(19) United States
(12) Patent Application Publication
(10) Pub. No.: US 2004/0174563 A1
(43) Pub. Date: Sep. 9, 2004

(54) Arranging images on a page

(76) Inventors: John J. Cassidy JR., San Diego, CA (US); William Cassidy, San Diego, CA (US); Steven T. Breidenbach, San Diego, CA (US); Stan McDaniel, San Diego, CA (US); James E. Sutton, Oceanside, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/378,989

(22) Filed: Mar. 3, 2003

(51) Int. Cl. G06F 15/00; H04N 1/387

(52) U.S. Cl. 358/1.18; 358/1.12; 358/450

(57) ABSTRACT

In one embodiment, a method of arranging a plurality of digital images on a page for printing is provided, which includes defining a current packing area on the page, identifying a largest size image of available images that will fit within the current packing area, defining a first arrangement of the identified largest size image in the current packing area, defining a second arrangement of the identified largest size in the current packing area, comparing the first arrangement to the second arrangement, and selecting one of the arrangements based on the comparison.

### BACKGROUND

Recent advances in digital imaging and printing technologies have enabled the production of high-quality prints of digital images using affordable, commercially available printing devices, for example, fluid ejection printing devices such as ink jet printers. Prints of photo-lab quality may be produced by printing the images onto special types of photo papers that have the textures and appearances of traditional photograph printing papers.

Special photograph printing papers may be quite expensive in comparison to ordinary printing paper. Therefore, to lower the cost of printing images on such papers, multiple images may be printed onto a single page. However, typical printing software programs do not attempt to arrange the images on a page in such a manner as to use the available space on the page in an efficient manner. Instead, these programs merely check whether an image will fit on a currently used page in an orientation specified by the user. If the image does not fit, it is put on a new page. Such printing methods may result in the inefficient use of expensive printing papers.

Various publishing software programs exist that allow a user to place images on a page in desired locations before printing the page. However, because the user typically places each individual image onto a page with these programs, the arrangement of images on the page may be a time-consuming and inefficient process. Furthermore, where printing a large number of images of a plurality of different sizes, it may be difficult for the user to determine whether earlier-filled pages have leftover space into which later images may be fit.

Other publishing programs have the capability to arrange images onto a page automatically. However, these programs typically arrange the photos in such a way as to make the page resemble a page from a photo album. The images are thus arranged to make the page as a whole appear aesthetically pleasing, rather than to increase the efficient utilization of page space.

### SUMMARY

In one embodiment, a method of arranging a plurality of digital images on a page for printing is provided, which includes defining a current packing area on the page, identifying a largest size image of available images that will fit within the current packing area, defining a first arrangement of the identified largest size image in the current packing area, defining a second arrangement of the identified largest size in the current packing area, comparing the first arrangement to the second arrangement, and selecting one of the arrangements based on the comparison.

### BRIEF DESCRIPTION OF THE DRAWINGS

FIG. 1 is a schematic depiction of an exemplary digital imaging, storage and printing system according to an embodiment of the present invention.

FIG. 2 is a plan view of an exemplary printing device user interface according to another embodiment of the present invention.

FIG. 3 is a flow diagram of a method of arranging a plurality of images on a page according to another embodiment of the present invention.

FIG. 4 is a flow diagram of a method of selecting a selected image arrangement from a plurality of test arrangements suitable for use with the embodiment of FIG. 3.

FIG. 5 is a plan view of an exemplary page having a plurality of images of a first size arranged in a first test arrangement.

FIG. 6 is a plan view of the page of FIG. 5, with the plurality of images of the first size arranged in a second test arrangement.

FIG. 7 is a plan view of the page of FIG. 5, with the first test arrangement selected as a selected image arrangement, and with a plurality of images of a second size arranged in a first test arrangement in the leftover space.

FIG. 8 is a plan view of the page of FIG. 7, with the plurality of images of a second size arranged in a second test arrangement.

FIG. 9 is a plan view of the page of FIG. 8, with the second test arrangement of the images of the second size selected as the selected image arrangement, and with a plurality of images of a third size arranged in a first test arrangement in the leftover space.

FIG. 10 is a plan view of the page of FIG. 9, with the plurality of images of the third size arranged in a second test arrangement, and with another image of the third size placed in the leftover space.

FIG. 11 is a plan view of a second exemplary page with a plurality of images of the first size arranged in a first test arrangement, showing a first decomposition of leftover space.

FIG. 12 is a plan view of the page of FIG. 11, with the plurality of images arranged in the first test arrangement, and showing a second decomposition of leftover space.

FIG. 13 is a plan view of the page of FIG. 11, with the plurality of images arranged in a second test arrangement.

FIG. 14 is a plan view of the page of FIG. 11, with the first test arrangement selected as the selected image arrangement, and with a plurality of images of a second size arranged in a first test arrangement.

FIG. 15 is a plan view of the page of FIG. 11, with the plurality of images of the second size arranged in a second test arrangement.

### DETAILED DESCRIPTION

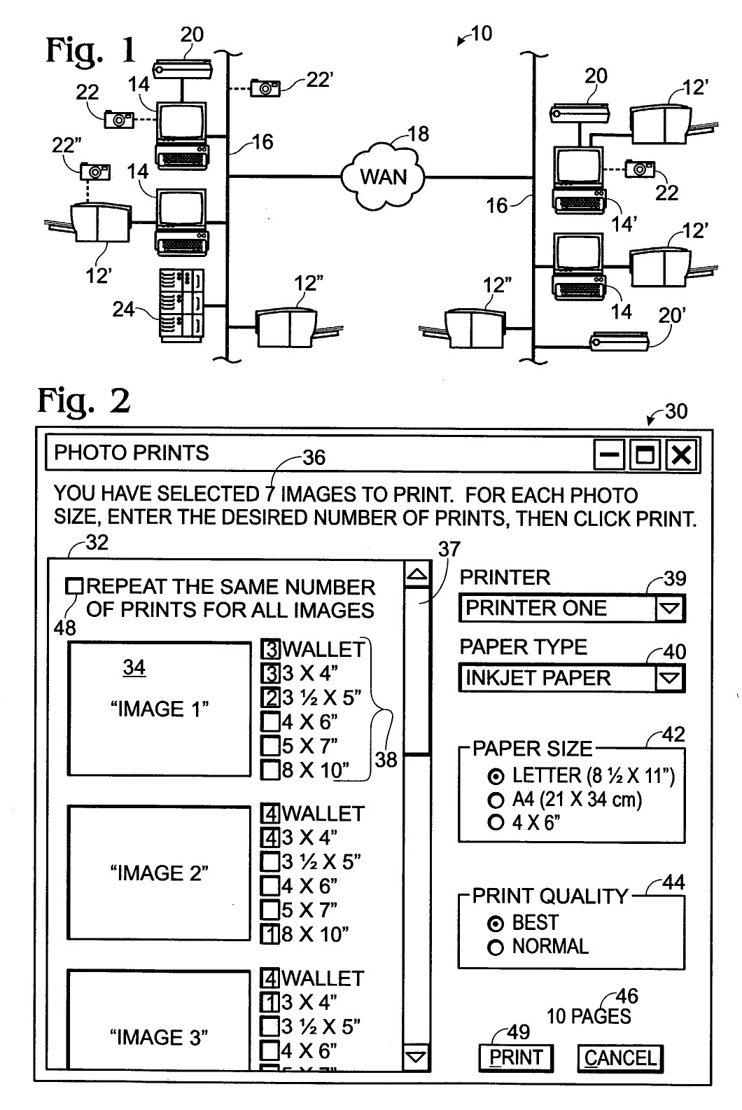

FIG. 1 shows, generally at 10, a schematic depiction of a digital imaging, storage and printing system demonstrating several exemplary use environments in which systems and methods of arranging digital images on a page may be implemented. For example, system 10 may include a plurality of printing devices 12 configured to print output from various image sources and storage devices. Some printing devices, indicated at 12′, may be connected directly to an associated computing device 14, while other printing devices, indicated at 12″, may be connected to image sources and storage devices via local area networks (LANs), indicated at 16. LANs 16 may be connected to one another via a wide area network (WAN) 18, allowing images generated or sourced on one LAN to be stored and/or printed on storage devices and printing devices on another LAN. Likewise, computing devices 14 may either be attached to one of LANs 16, or may be free of any network connections, as indicated at 14′.

System 10 also may include a plurality of digital image generating devices. For example, system 10 may include one or more scanners 20. Scanners 20 may be connected to associated computing devices 14, or connected directly to LAN 16 and controlled remotely, as indicated at 20.′ System 10 may also include the capability to accept the connection of one or more digital cameras or digital image storage devices (for example, hard or floppy disk drives, CD-ROM drives, FLASH memory cards, Memory Stick storage devices, available from the Sony Corporation, Microdrive storage devices, available from the IBM Corporation, EPROM or EEPROM storage devices, etc.). In the depicted embodiment, several digital cameras 22 are shown connected to system 10 at various locations on the system. Digital cameras 22 may be any suitable type of digital image capture device, including digital video and still cameras. Digital cameras 22 may be connected to system 10 only during image transfer, so the connections of the digital cameras to system 10 are shown in dashed lines indicating their temporary nature. Digital cameras 22 may be connected to computing devices 14, to LANs 16 (as indicated at 22′), or directly to a suitably configured printing device, as indicated at 22″.

System 10 also may include storage devices for storing images produced by digital cameras 22, scanners 20, and other image sources. For example, computing devices 14 may be used to store, as well as process, digital images from cameras 22 and scanners 20. Furthermore, system 10 may include other storage and/or processing devices, such as one or more servers 24.

As described above, printing devices 12 may be used to print high-quality reproductions of digital images stored on computing devices 14, servers 24, cameras 22, etc. Typically, a user may control the printing of a selected image via printing device control software located in memory in one of computing devices 14, servers 24, cameras 22, etc. The printing device control software may also be located on another type of storable medium, such as a CD-ROM, floppy disk, etc., and loaded onto a desired component of system 10 before use.

The printing device control software typically includes code for displaying a user interface on a display associated with computing device, server, camera, etc. on which the software is running. One example of a suitable printing device control software user interface is shown generally at 30 in FIG. 2. User interface 30 includes a photo display field 32 that shows a thumbnail-sized, or otherwise reduced size, rendition of each image 34 the user has selected for printing. A caption 36 at the top of user interface 30 may be used to indicate how many images the user has selected for printing. Where more images are selected than are displayable within photo display field 32, a scroll bar 37 may be supplied to allow a user to scroll other images into the photo display field.

Next to each image, a print size and quantity field 38 may be provided that allows the user to select how many prints of each size the user wants to print for each image. For example, in the depicted embodiment, three wallet-sized prints, three 3×4″ prints, and two 3½×5″ prints are to be printed for IMAGE 1. Likewise, four wallet-sized prints, four 3×4″ prints, and one 8×10″ print are to be printed for IMAGE 2. User interface 30 also may include a printer selection field 39, a paper type field 40, a paper size field 42, a print quality field 44, and a total pages field 46. Printer selection field 39 may allow the user to specify a desired printing device to be used for printing, where multiple printing devices are available. Paper type field 40 may allow the user to select what type of paper the image is being printed on so that a correct mixture of printing fluids may be used for each supported paper type for accurate color reproduction and optimum appearance. Paper size field 42 may allow the user to select a desired size of paper for printing, and print quality field 44 may allow a user to select print quality in order to preserve printing material (e.g., ink fluids, dry toner, etc) where a print of the highest quality is not required.

From the number of images of each size selected, the printing device control software, via methods described in more detail below, may determine an arrangement of the images on pages of the selected paper size, and then may determine a total number of pages for printing. The total number of pages needed for printing may then be displayed in total pages field 46 so that the user may ensure sufficient paper is loaded in the selected printing device. Total pages field 46 may be updated with every change in the number of prints requested so that the total number of pages displayed in the field is always up-to-date.

The depicted exemplary user interface 30 may offer several advantages over other user interface designs. First, unlike many known printing device user interfaces, user interface 30 may place all information related to the printing of images on a single visual field. No menus or submenus are needed to allow a user to specify how many prints of each size are desired for each image. Additionally, user interface 30 need not use dialog boxes for paper selection, print quality, and other features commonly controlled through dialog boxes. Furthermore, user interface 30 may include a “same number for all” checkbox 48, allowing a user to check the box after selecting a desired quantity of each size of prints for a single image to apply the choices to all images.

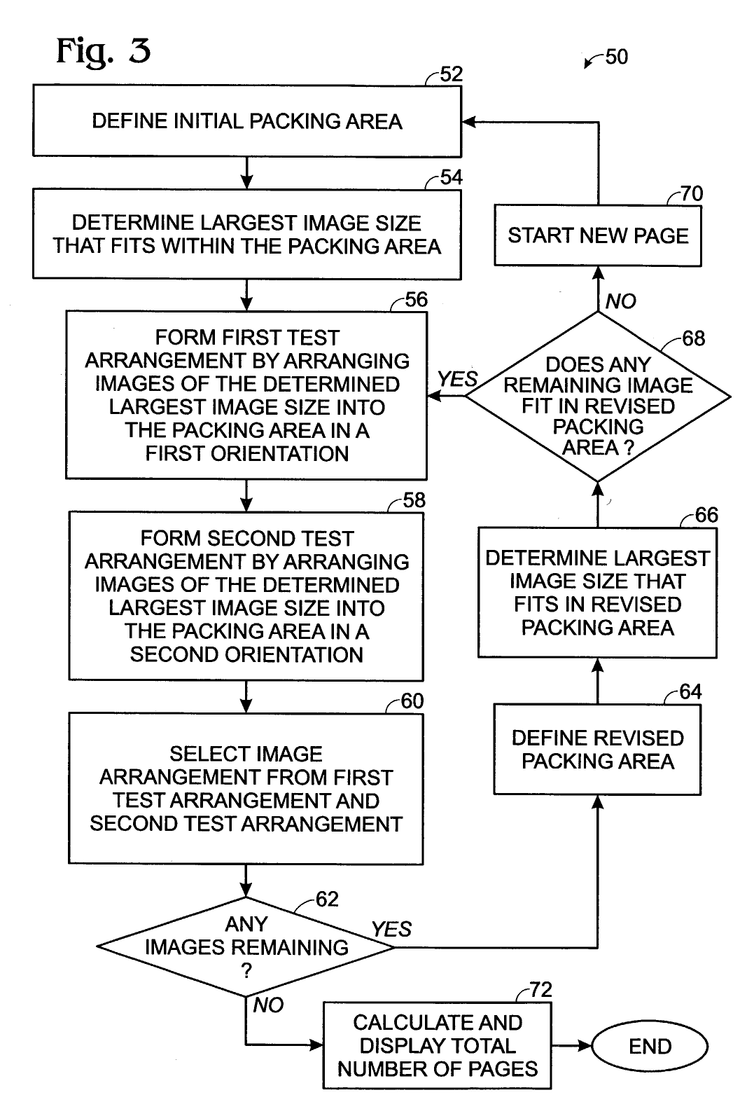

As described above, special photo papers may be significantly more expensive than ordinary papers. Thus, the printing control software may be configured to pack the desired prints onto pages of the selected page size in a way that efficiently utilizes the entire page. FIG. 3 shows, generally at 50, one exemplary embodiment of a method of arranging a plurality of digital images (generally of a plurality of different sizes) onto a page in an efficient manner for printing. Method 50 includes defining an initial packing area on the page at 52, determining a largest image size of the plurality of digital images that will fit within the initial packing area at 54, forming a first test arrangement by placing at least one selected image of the determined largest image size into the initial packing area in a first orientation at 56, forming a second test arrangement by placing the selected image or images into the initial packing area in a second orientation different from the first orientation at 58, and selecting an image arrangement for printing by comparing the first test arrangement to the second test arrangement at 60 using preselected criteria. The preselected criteria are described in more detail below.

After selecting an image arrangement for printing, method 50 next may include checking, at 62, whether any images remain to be fitted onto the page. If so, a revised packing area may be defined, at 64, from the remaining useable space on the page, and a largest image size that fits in the revised packing area may be determined at 66. It is possible that, if the revised packing area is sufficiently small, no remaining images may fit within the revised packing area, as indicated by decision box 68. If no remaining images fit within the revised packing area, then a new page may be started, and a new initial packing area may be defined to begin the process anew. If, on the other hand, at least one remaining image fits within the revised packing area, then the image or images are arranged in the revised packing area in a first test arrangement at 56, then in a second test arrangement at 58. Next, an image arrangement is again selected, at 60, from the first test arrangement and second test arrangement. At this point, if there are no images remaining, then the total number of pages utilized is calculated and displayed at 72, typically on user interface 30. A user may then select “PRINT” button 49 on user interface 30 to start printing the selected images.

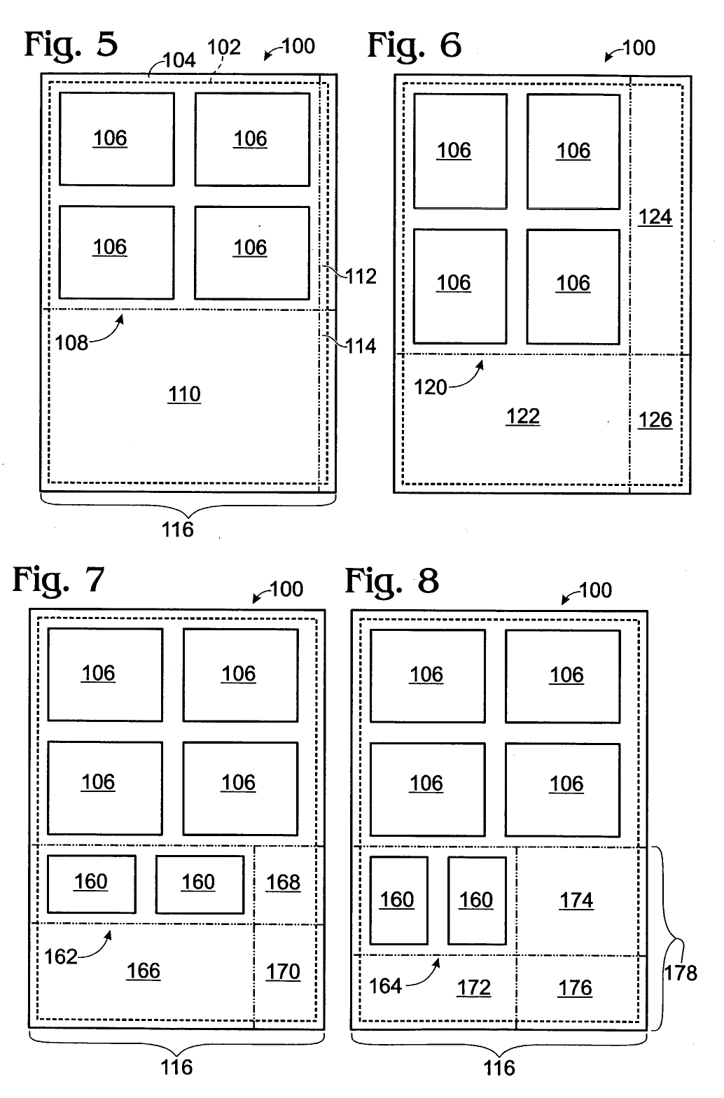

The initial packing area may be defined, at 52, in any suitable manner. For example, the initial packing area may be defined on a page based on selection of a desired margin via a page setup menu or dialog box. Likewise, the initial packing area may be defined based on a physical or hardware limitation regarding the actual area of the page that may be utilized by a selected printing device, or based on a fixed margin set by the printing device control software. FIG. 5 shows a schematic depiction of an exemplary initial packing area, indicated by dashed line 102, defined on a page 100. The depicted initial packing area 102 is defined as the entire page minus a thin margin 104 around the page perimeter, but it will be appreciated that the initial packing area may have any other suitable dimensions.

In one embodiment, once the initial packing area is defined, the largest image size that fits within the packing area is determined, at 54, by comparing the dimensions of each image size to the dimensions of the initial packing area. Typically, even the largest image size will fit within the initial packing area. Thus, determining the largest image size that fits within the initial packing area may simply involve determining the largest remaining image size to be fitted onto a page.

After determining the largest image size that fits into the initial packing area, a first test arrangement is formed at 56. The first test arrangement is a first layout of images of the largest determined size within the initial packing area. In the first test arrangement depicted in FIG. 5, all of the images of the largest determined image size are oriented in the same orientation. FIG. 5 shows one example of a first test arrangement generally at 108, where four images 106 are arranged on page 100. The images of the first test arrangement 108 are shown each in a landscape orientation, but it will be appreciated that the images may be oriented in any other suitable orientation. Furthermore, each image may be oriented in an orientation different from the other images, if desired.

When forming the first test arrangement at 54, images 106 of the largest determined size may be added to the initial packing area either until no more images of the largest determined size remain to be fitted onto the page, or until no more images of the largest determined size fit onto the page. In the exemplary first test arrangement of FIG. 5, it will be noted that room exists for more images of the largest determined size, which implies that all of images 106 of the largest determined size that are to be printed have been fitted onto page 100.

Images 106 may be added to the initial packing area in any suitable manner to form first test arrangement 108. For example, the first image 106 may be added to the upper left-hand corner of initial packing area 102, and then other images 106 may be added either across the top of the page in a row, or along the side of the page in a column. Likewise, the first image 106 may be added to any other corner of initial packing area 102, or even in a location along a side or in the middle of the initial packing area. In the depicted embodiment, the four images 106 are arranged in rows starting from the top of initial packing area 102.

Images 106 may be separated by any suitable distance. The distance by which images 106 are spaced may be influenced by several different considerations. For example, images 106 may be spaced fairly closely together to utilize the space on page 100 more efficiently. On the other hand, images 106 may be spaced somewhat further apart to increase the ease with which the images may be separated with scissors, a blade, etc. Likewise, spacing images 106 further apart may increase the amount of white space around the print of the image for use as a border. The spacing of images 106 may be accomplished in any suitable manner. For example, a margin of white space may be added around each image 106 before the image is added to initial packing area 102, or each image could be placed in the initial packing area a specified distance from other images already present in the initial packing area.

Once first test arrangement 108 is formed, the leftover space on page 100 may be broken down into rectangular regions for comparison with the leftover space of other test arrangements, as described in more detail below. Three regions of leftover space are defined for first test arrangement 108 of FIG. 5: a lower leftover region 110, a side leftover region 112, and a corner leftover region 114. When comparing the leftover space of first test arrangement 108 to other test arrangements, corner leftover region 114 is typically combined with either lower leftover region 110 or side leftover region 112. Any desired criteria may be used to determine which leftover region to combine with corner leftover region 114. For example, corner leftover region 114 may be combined with the leftover region that has the largest small dimension, which is the length of the shorter side of the leftover region. Under this scheme, in the example depicted in FIG. 5, corner leftover region 114 would be combined with lower leftover region 110 for the purposes of comparison to the second test arrangement. It will be appreciated that the terms “lower”, “side”, and “corner” used herein to describe the leftover spaces are meant only to describe the location of the leftover spaces as they appear in the figures, and are not intended to describe any limitation regarding the actual location of the leftover spaces on an actual page. This is because the location of leftover space is be determined by the location of images on the page, and, as described above, the images may be positioned in any other suitable manner on the page than the positions described herein.

After forming first test arrangement 108, a second test arrangement may be formed for comparison to the first test arrangement. One exemplary second test arrangement is shown generally at 120 in FIG. 6. As with first test arrangement 108, each image 106 in second test arrangement 120 is shown in the same orientation as the other images 106 in the same test arrangement. However, in second test arrangement 120, each images 106 is rotated approximately ninety degrees relative to the images in first test arrangement 108. It will be appreciated that the depicted orientations are merely exemplary, and that images 106 may be oriented in any other suitable orientation, and also may be rotated either more or less than 90 degrees from the images in first test arrangement 108.

After second test arrangement 120 is formed, the leftover space of the second test arrangement is broken down into lower leftover region 122, side leftover region 124, and corner leftover region 126. Using the exemplary rule for combining leftover regions described above, corner leftover region 126 may be combined with lower leftover region 122 for purposes of comparing with first test arrangement 108, as the lower leftover region has the largest small dimension.

After forming both first test arrangement 108 and second test arrangement 120, one of the image arrangements is selected based on a comparison of the arrangements in view of a set of predetermined criteria. Any suitable set of predetermined criteria may be used to compare first test arrangement 108 and second test arrangement 120. For example, the two test arrangements may be compared using a set of criteria containing only a single criterion, or more than one criterion. Where the set of criteria has more than one criterion, the criteria may be applied in any suitable order.

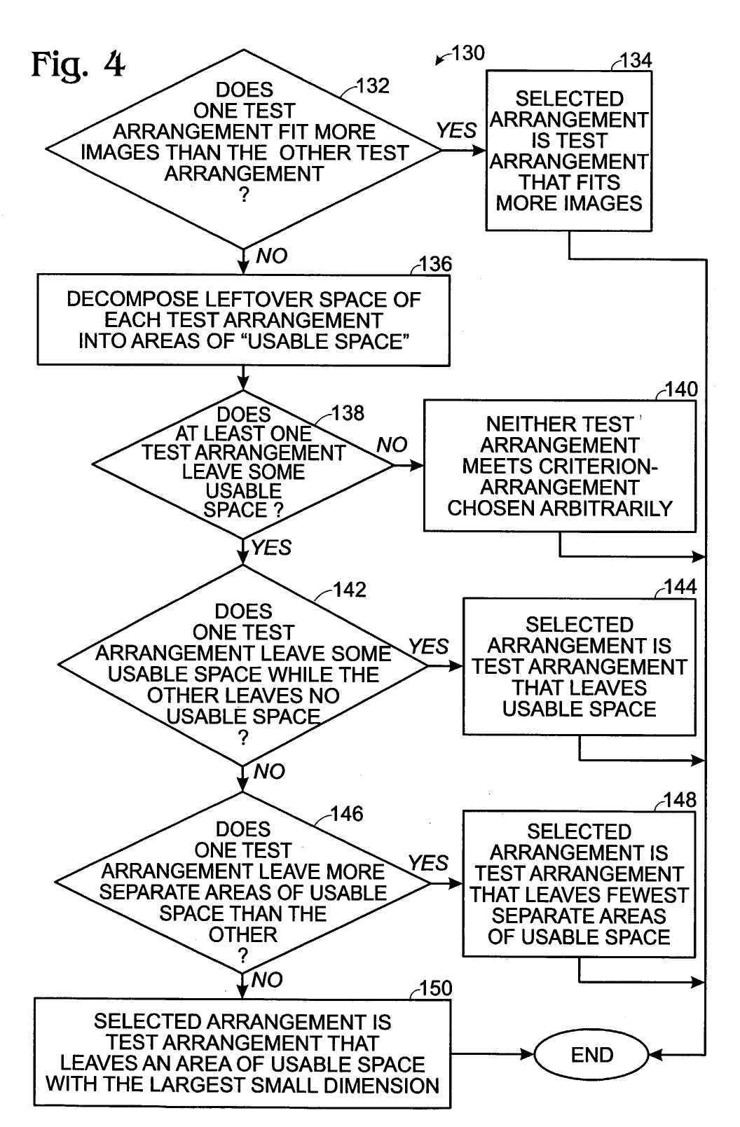

FIG. 4 shows, generally at 130, one exemplary set of criteria and method for selecting a selected image arrangement from first test arrangement 108 and second test arrangement 120. First, the two test arrangements may be compared at 132 to determine whether one test arrangement fits more images than the other test images. If this is true, then the selected image arrangement may be that which fits the most images into the initial packing area, as indicated at 134. In the example depicted in FIGS. 5-6, both test arrangements fit all four images. Thus, a second criterion may be applied to determine which test arrangement is the image arrangement to select.

Next, first test arrangement 108 may be decomposed into leftover regions 110, 112 and 114, and second test arrangement 120 may be decomposed into leftover regions 122, 124 and 126, as described above and illustrated at 136. Then, the leftover regions may be compared at 138 to determine whether each leftover region includes at least some useable space. Useable space may be defined as space into which an image of any supported size may be fitted. If neither first test arrangement 108 or second test arrangement 120 leaves any useable space, then neither test arrangement meets the criterion, and the selected image arrangement may be chosen arbitrarily, as indicated at 140.

Next, as indicated at 142, if one test arrangement leaves some useable space while the other does not, then the selected image arrangement may be the arrangement that leaves useable space, as indicated at 144. On the other hand, if both test arrangements leave at least some useable space, as in the example of FIGS. 5-6, then the areas of useable space may be compared to determine a selected image arrangement. First, the first and second test arrangements are compared at 146 to determine which leaves the fewest separate areas of useable space. The test arrangement that leaves the fewest separate areas of useable space may be selected as the selected image arrangement, as indicated at 148. As described above, some areas of useable space may be combined together to create a larger area, so the combined regions may be treated as a single region for this comparison.

Applying this criterion to the test arrangements of FIGS. 5 and 6, first test arrangement 108 leaves one area of useable space (lower useable region 110 combined with corner useable region 114), and second test arrangement 120 also leaves one area of useable region (again, the lower and corner useable regions combined). Thus, yet another criterion may be used to select a selected image arrangement.

Next, the regions of useable space in the two test arrangements may be compared to determine which region of useable space has the largest small dimension, as indicated at 150. Referring to the example of FIGS. 5-6, first test arrangement 108 leaves a region of useable space with the largest small dimension. Thus, first test arrangement 108 may be selected as the selected image arrangement. It will be appreciated that any one criterion, or any subset of these criteria, from FIG. 4 may be used instead of the entire set of criteria without departing from the scope of the present disclosure. Furthermore, it will be appreciated that the criteria listed above, or any other desired criteria, may be applied in any desired order other than the orders disclosed herein.

Referring again to FIG. 3, after an image arrangement is selected at 60, it is determine whether any images remain to be placed on a page. If no images remain, then the total number of pages to be printed may be calculated, at 72, and displayed on user interface 30 (user interface 30 is shown in FIG. 2). At this point, the page or pages containing the images are ready to be printed by selecting PRINT button 49 on user interface 30.

On the other hand, if some images remain to be arranged on a page at 62, then a revised packing area may be defined at 64, and a largest image size that fits in the revised packing area may be determined at 66. In the example of FIGS. 5-6, the revised packing area, indicated generally at 116 in FIG. 5, may be defined as the combination of lower leftover region 110 and corner leftover region 112 of first test arrangement (and selected image arrangement) 108.

The largest image size that fits in revised packing area 116 may be determined in any suitable manner. For example, where a selected image size may be oriented such that both dimensions of the image are smaller than the same dimensions of revised packing area 116, the selected image size may be fitted into the revised packing area. The largest image size that may be fitted into revised packing area 116 may thus be determined by starting with the largest image size and comparing the image dimensions to the revised packing area dimensions until an image size that fits is found. Alternatively, the largest image size that may be fitted into revised packing area 116 may be determined by starting with the smallest image size to be printed and comparing dimensions until an image size that does not fit is found. It will be appreciated that these methods of determining the largest image size that fits within revised packing area 116 are merely exemplary, and that any other suitable method may be used.

As described above, it is possible that no remaining image may be fitted into revised packing area 116. If this is true, then a new page may be begun at 70, and method 50 may be performed again for the new page. If, however, some remaining images do fit within revised packing area 116, then one or more images of the largest size that fits within revised packing area 116 may be arranged within the revised packing area. FIG. 7 shows an example of two images 160 of a smaller size than images 106 arranged in revised packing area 116 in a first test arrangement 162, and FIG. 8 shows images 160 arranged in a second test arrangement 164. This example assumes that only two images 160 remain to be placed on a page, and that there are thus no other images 160 available to fill the revised packing area more completely.

Because both test arrangements allow the two images 160 to be fitted into revised packing area 116, the leftover space may again be decomposed for comparison. As shown in FIG. 7, first test arrangement 162 may be broken down into a lower leftover space 166, a side leftover space 168, and a corner leftover space 170. Likewise, second test arrangement 164 may be broken down into a lower leftover space 172, a side leftover space 174, and a corner leftover space 176. Then, the leftover spaces may be consolidated as described above. For example, because lower leftover space 166 of first test arrangement 162 has a larger small dimension than side leftover space 168, corner leftover space 170 may be consolidated with lower leftover space 166. However, because side leftover space 174 has the largest small dimension in the second test arrangement 164, the side leftover space may be combined with corner leftover space 176.

After the leftover space is consolidated, the leftover spaces of the two test arrangements may be compared using criteria 138, 142 and 146 of method 130 shown in FIG. 4. First applying criteria 138 and 142, both test arrangements leave at least some useable space. Next applying criteria 146, it appears that both test arrangements may leave two areas of useable space (the corner area of useable space combined with the space with the largest small dimension, and the space with the smallest small dimension). In this case, according to criteria 150, the selected image arrangement is that which leaves an area of useable space with the largest small dimension, or second test arrangement 164.

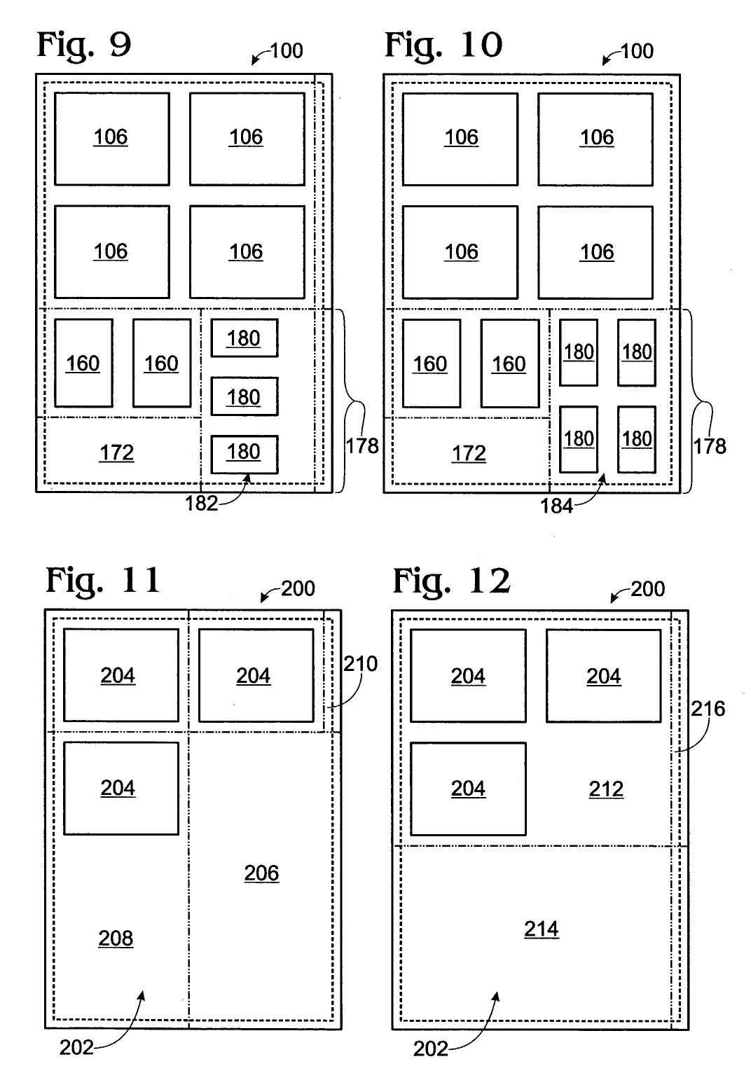

Once the selected image arrangement for images 160 has been chosen, method 30 is again repeated for each area of leftover space on page 100. First, side leftover space 174 and corner leftover space 176 are redefined as a revised packing area 178, the largest remaining image 180 that fits within the revised packing area is determined, and two test arrangements are formed. FIG. 9 illustrates a first test arrangement 182 for images 180, and FIG. 10 illustrates a second test arrangement 184 for images 180. Here, first test arrangement 182 fits only three images into revised packing area 178, while second test arrangement 184 fits four images into revised packing area 178. Therefore, according to criterion 132 of FIG. 4, second test arrangement 184 is the selected image arrangement for images 180. The above described steps may then be repeated for leftover space 172 to fill the rest of page 100, if there are any smaller images than images 180 to be printed.

As described above, FIGS. 5-10 illustrate an example of a process of arranging images in which the images fit into rectangular-shaped arrangements. However, in some situations, images may not form rectangular-shaped arrangements. In these situations, the leftover space may be decomposed in a different manner than described above. FIG. 11 illustrates a first test arrangement 202 of three images 204 on a page 200. Test arrangement 202 shows two images 204 arranged in a top row, and a single image 204 arranged in a second row below the top row. Again, it will be appreciated that the particular arrangements shown herein are merely exemplary, and that the three images 204 may be arranged in any other suitable manner on page 200.

Due to the irregular shape of the overall arrangement of images 204 on page 200, the leftover space may be decomposed into rectangles in different ways. FIG. 11 shows a first decomposition of leftover space into a large central region 206, a first side region 208, and a second side region 210. FIG. 12 shows a second decomposition of leftover space into a smaller center region 212, as well as first and second side regions 214 and 216.

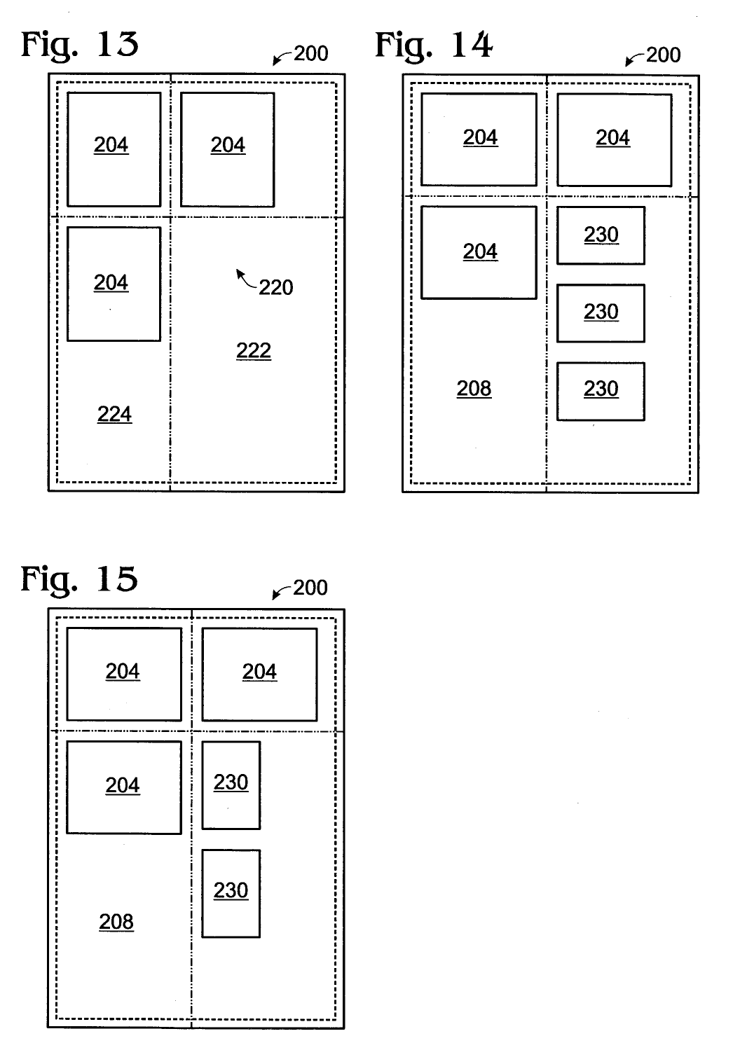

Comparing the first decomposition of leftover space shown in FIG. 11 to the second decomposition of leftover space shown in FIG. 12, the first decomposition space leaves a larger center region 206, while the second decomposition leaves a larger side region 214. For the purposes of comparing the leftover space to that left by a second test arrangement, shown in FIG. 13 at 220, either the leftover space decomposition of FIG. 11 or the decomposition of FIG. 12 may be used. The decomposition scheme of FIG. 11 may result in the creation of a larger center leftover region 206 than the decomposition of FIG. 12, as the decomposition scheme of FIG. 11 may result in the formation of a center region 206 with dimensions at least as large as, and possibly larger than, the dimensions of one of images 204, while the decomposition scheme of FIG. 12 may result in a center region 206 with dimensions only as large as one of images 204. For the purposes of example, the decomposition of FIG. 11 is used to illustrate the arrangement of additional images.

After forming first test arrangement 202 (FIG. 11) and second test arrangement 220 (FIG. 13), a selected image arrangement may be selected via method 130 in FIG. 4. First applying criterion 132, both test arrangements accommodate all three images, so the leftover space of first test arrangement 202 is compared to the leftover space of second test arrangement 220. The areas of leftover space for second test arrangement 220 are shown as center leftover region 222, and two side regions 224, 226. First applying criteria 138 and 140, both test arrangements leave at least some useable space, as center leftover regions 206 and 222 each may fit an image of smaller size than images 204. Next applying criterion 142, second test arrangement 220 may leave three separate areas of useable space (center region 222 and side regions 224, 226), while first test arrangement 202 may leave only two areas of useable space (center region 206 and side region 208). Therefore, first test arrangement 202 in FIG. 11 may be selected as the selected image arrangement, as it leaves the fewest separate areas of useable space.

FIGS. 14 and 15 show exemplary test arrangements of images 230 placed in center region 206 of first test arrangement (and selected image arrangement) 202. Three images fit within center region 206 in FIG. 14, while only two images fit within center region in FIG. 15. Thus, the test arrangement of FIG. 14 may be selected as the selected image arrangement for images 230. Leftover region 208 may next be packed with images following the same methodologies described above.

Although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A method of arranging a plurality of digital images on a page for printing, comprising:
defining a current packing area on the page;
identifying a largest size image of available images that will fit within the current packing area;
defining a first arrangement of the identified largest size image in the current packing area;
defining a second arrangement of the identified largest size in the current packing area;
comparing the first arrangement to the second arrangement; and
selecting one of the arrangements based on the comparison.

2. The method of claim 1, wherein defining the first arrangement includes placing plural images of the identified largest size in the current packing area in a first orientation and defining the second arrangement includes placing plural images of the identified largest size in the current packing area in a second orientation.

3. The method of claim 2, wherein the second orientation is rotated approximately ninety degrees relative to the first orientation.

4. The method of claim 2, wherein placing plural images includes placing all of the identified largest size images in the current packing area.

5. The method of claim 2, wherein placing plural images includes placing the identified largest size images in the current packing area until no more of the identified largest size images fit in the current packing area.

6. The method of claim 1, wherein defining the first arrangement includes placing the identified largest size images horizontally across the current packing area to define a first row and in a second row immediately below the first row.

7. The method of claim 1, wherein selecting one of the arrangements includes selecting an arrangement that fits a greatest number of images into the current packing area.

8. A method of arranging a plurality of digital images on a page for printing, comprising:
defining a current packing area on the page;
identifying a largest size image of available images that will fit within the current packing area;
defining a first arrangement of the identified largest size image in the current packing area;
determining a first amount of useable leftover space on the page for the first arrangement;
defining a second arrangement of the identified largest size in the current packing area;
determining a second amount of useable leftover space on the page for the second arrangement;
comparing the first arrangement to the second arrangement; and
selecting one of the arrangements based on the comparison.

9. The method of claim 8, wherein selecting one of the arrangements includes selecting an arrangement that leaves useable leftover space into which an available image will fit.

10. The method of claim 8, wherein selecting one of the arrangements includes selecting an arrangement that leaves a least number of separate areas of useable leftover space.

11. The method of claim 8, wherein selecting one of the arrangements includes selecting an arrangement that leaves an area of useable leftover space with a largest small dimension.

12. A method of arranging a plurality of digital images on a page for printing, comprising:
defining a current packing area on the page;
identifying a largest size image of available images that will fit within the current packing area;
defining a first arrangement of the identified largest size image in the current packing area;
defining a second arrangement of the identified largest size in the current packing area;
comparing the first arrangement to the second arrangement;
selecting one of the arrangements based on the comparison; and
after selecting one of the arrangements, defining a new current packing area on the page, the new current packing area being defined by an area of useable leftover space not occupied by an image.

13. The method of claim 12, further comprising identifying a new largest size image of available images that will fit in the new current packing area, defining a first arrangement of the identified new largest size image in the new packing area, defining a second arrangement of the identified new largest size in the new packing area, comparing the first arrangement to the second arrangement, and selecting one of the arrangements based on the comparison.

14. The method of claim 13, further comprising iteratively repeating the defining a new current packing area, identifying a new largest size image of available images that will fit in the new current packing area, defining a first arrangement of the identified new largest size image in the new packing area, defining a second arrangement of the identified new largest size in the new packing area, comparing the first arrangement to the second arrangement, and selecting one of the arrangements based on the comparison until no useable leftover space remains on the page.

15. The method of claim 14, further comprising defining a current packing area on a next page where no leftover useable space remains on the page and at least one image remains available. 19. The method of claim 18, further comprising determining a number of pages on which the plurality of digital images are to be printed, and displaying the number of pages on a display.

16. A method of arranging a plurality of images for printing, comprising:
defining a packing area on a current page;
identifying a largest size of the plurality of images that may be correlated with the packing area;
defining a first arrangement by correlating at least one image of the identified largest size with the packing area;
defining a second arrangement by correlating at least one image of the identified largest size with the packing area;
selecting an image arrangement from the first arrangement and the second arrangement;
defining a new packing area on the current page as an area on the page not yet correlated with an image; and
repeating the acts of identifying, defining, defining, selecting and defining for successive new packing areas until either no more images may be correlated with a packing area, or until all images have been correlated with a packing area.

17. The method of claim 16, further comprising repeating (the defining, identifying, defining, defining, selecting and defining for a new page if no more images may be correlated with a packing area and at least one image of the plurality of images has not been correlated with a packing area.

18. The method of claim 16, wherein selecting an image arrangement includes selecting an arrangement that correlates a greatest number of images with the packing area.

19. A computer-readable storage medium having instructions stored thereon, the instructions being executable to:
define a current packing area on the page;
identify a largest size image of available images that will fit within the current packing area;
define a first arrangement of the identified largest size image in the current packing area;
define a second arrangement of the identified largest size in the current packing area;
compare the first arrangement to the second arrangement; and
select one of the arrangements based on the comparison.

20. The computer-readable storage medium of claim 19, wherein the instructions executable to define the first arrangement include instructions executable to place plural images of the identified largest size in the current packing area in a first orientation and the instructions executable to define the second arrangement include instructions executable to place plural images of the identified largest size in the current packing area in a second orientation.

21. The computer-readable storage medium of claim 20, wherein the second orientation is rotated approximately ninety degrees relative to the first orientation.

22. The computer-readable storage medium of claim 20, wherein the instructions executable to place plural images include instructions executable to place all of the identified largest size images in the current packing area.

23. The computer-readable storage medium of claim 20, wherein the instructions executable to place plural images include instructions executable to place the identified largest size images in the current packing area until no more of the identified largest size images fit in the current packing area.

24. The computer-readable storage medium of claim 19, wherein the instructions executable to define the first arrangement include instructions executable to place the identified largest size images horizontally across the current packing area to define a first row and in a second row immediately below the first row.

25. The computer-readable storage medium of claim 19, wherein the instructions executable to select one of the arrangements includes instructions executable to select an arrangement that fits a greatest number of images into the current packing area.

26. A computer-readable storage medium having instructions stored thereon, the instructions being executable to:
define a current packing area on the page;
identify a largest size image of available images that will fit within the current packing area;
define a first arrangement of the identified largest size image in the current packing area;
determine a first amount of useable leftover space on the page for the first arrangement;
define a second arrangement of the identified largest size in the current packing area;
determine a second amount of useable leftover space on the page for the second arrangement;
compare the first arrangement to the second arrangement; and
select one of the arrangements based on the comparison.

27. The computer-readable storage medium of claim 26, wherein the instructions executable to select one of the arrangements include instructions executable to select an arrangement that leaves useable leftover space into which an available image will fit.

28. The computer-readable storage medium of claim 26, wherein the instructions executable to select one of the arrangements include instructions executable to select an arrangement that leaves a least number of separate areas of useable leftover space.

29. The computer-readable storage medium of claim 26, wherein the instructions executable to select one of the arrangements include instructions executable to select an arrangement that leaves an area of useable leftover space with a largest small dimension.

30. A computer-readable storage medium having instructions stored thereon, the instructions being executable to:
define a current packing area on the page;
identify a largest size image of available images that will fit within the current packing area;
define a first arrangement of the identified largest size image in the current packing area;
define a second arrangement of the identified largest size in the current packing area;
compare the first arrangement to the second arrangement;
select one of the arrangements based on the comparison; and
after selection of one of the arrangements, to define a new current packing area on the page, the new current packing area being defined by an area of useable leftover space not occupied by an image.

31. The computer-readable storage medium of claim 30, further comprising instructions executable to identify a new largest size image of available images that will fit in the new current packing area, define a first arrangement of the identified new largest size image in the new packing area, define a second arrangement of the identified new largest size in the new packing area, compare the first arrangement to the second arrangement, and select one of the arrangements based on the comparison.

32. The computer-readable storage medium of claim 31, further comprising instructions executable to iteratively repeat the instructions executable to define a new current packing area, identify a new largest size image of available images that will fit in the new current packing area, define a first arrangement of the identified new largest size image in the new packing area, define a second arrangement of the identified new largest size in the new packing area, compare the first arrangement to the second arrangement, and select one of the arrangements based on the comparison until no useable leftover space remains on the page.

33. The computer-readable storage medium of claim 32, further comprising instructions executable to define a current packing area on a next page where no leftover useable space remains on the page and at least one image remains available.

34. The computer-readable storage medium of claim 33, further comprising instructions executable to determine a number of pages on which the plurality of digital images are to be printed, and displaying the number of pages on a display.

35. A computer-readable storage medium having instructions stored thereon, the instructions being executable to:
define a packing area on a current page;
identify a largest size of the plurality of images that may be correlated with the packing area;
define a first arrangement by correlating at least one image of the identified largest size with the packing area;
define a second arrangement by correlating at least one image of the identified largest size with the packing area;
selecting an image arrangement from the first arrangement and the second arrangement;
define a new packing area on the current page as an area on the page not yet correlated with an image; and
repeat the instructions executable to identify, define, define, select and define for successive new packing areas until either no more images may be correlated with a packing area, or until all images have been correlated with a packing area.

36. The computer-readable storage medium of claim 35, further comprising instructions executable to repeat the instructions executable to define, identify, define, define, select and define for a new page if no more images may be correlated with a packing area and at least one image of the plurality of images has not been correlated with a packing area.

37. The computer-readable storage medium of claim 35, wherein the instructions executable to select an image arrangement include instructions executable to select an arrangement that correlates a greatest number of images with the packing area.

38. Apparatus for directing printing of digital images on a printing device, the apparatus comprising:
a user interface configured to receive size selections for images to be printed, such received size selections defining a set of available images; and
a processor in selected communication with the printing device, the processor being configured to:
define a packing area on a page,
identify a largest image size that will fit within the packing area, such largest image size being selected from the received size selections of the set of available images;
define a first arrangement with one or more images of the identified largest image size in the packing area, each in a first orientation;
define a second arrangement with one or more images of the identified largest image size in the packing area, each in a second orientation different from the first orientation;
select an image arrangement by comparing the first arrangement to the second arrangement using preselected criteria; and
communicate the selected image arrangement to the printing device for printing.

39. The apparatus of claim 38, wherein the processor is further configured to remove the one or more images of the selected image arrangement from the set of available images.

40. The apparatus of claim 39, wherein, prior to communicating the selected image arrangement to the printing device, the processor is further configured to:
define a new packing area in a space not occupied by an image of the selected image arrangement;
identify a new largest size of available images that will fit in the new current packing area;
define a new first arrangement with one or more newly selected images of the new largest size in the new current packing area in a new first orientation;
define a new second arrangement with one or more newly selected images of the new largest size in the new current packing area in a new second orientation; and
select an image arrangement from the new first arrangement and new second arrangement using preselected criteria.

41. The apparatus of claim 40, wherein the processor is further configured to iteratively define, identify, define, define and select until no useable space remains on the page.

42. The apparatus of claim 41, wherein the processor is further configured to define a current packing area on a next page where no useable space remains on the page and at least one image remains in the set of available images.

43. A method of arranging a plurality of digital images on a page for printing, comprising:
defining a current packing area on the page;
identifying a largest size of available images that will fit within the current packing area; and
selecting an image arrangement for printing by comparing a first test image arrangement to a second test image arrangement using preselected criteria, the first test image arrangement including a selected image of the identified largest size in the current packing area in a first orientation and the second test image arrangement including a selected image of the identified largest size in the current packing area in a second orientation different from the first orientation.
